(19) United States
(12) Patent Application Publication
(10) Pub. No.: US 2005/0015313 A1
(43) Pub. Date: Jan. 20, 2005

(54) Data managing system and method for hair processing spot

(75) Inventor: Miho Eto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION

(21) Appl. No.: 10/892,148

(22) Filed: Jul. 16, 2004

(30) Foreign Application Priority Data
Jul. 18, 2003 (JP) 276399/2003

(51) Int. Cl. G06F 17/60

(52) U.S. Cl. 705/27

(57) ABSTRACT

A data managing system for a hair processing spot comprises a data terminal unit including a display/operation panel having at least two touch panels, one being a first display/operation panel disposed to be visible and readily operable from the operator side, the other being a second display/operation panel disposed to be visible and readily operable from the customer side, and a storing unit including a database capable of being accessed from the data terminal unit. The data terminal unit is arranged to cause display, on the second display/operation panel, of data concerning predetermined items scheduled to be visually recognized from the customer side, among data inputted, retrieved for or obtained on the basis of a predetermined operation on the first display/operation panel.

### BACKGROUND OF THE INVENTION

This application claims benefit of Japanese Patent Application No. 2003-276399 filed on Jul. 18, 2003, the contents of which are incorporated by the reference.

The present invention relates to data managing systems and methods for hair processing spots.

In beauty parlors and barber shops (i.e., hair processing spots), systematization is not advanced so much, and data processing terminal are limited in use to accounting and store management, and has not be fully made use of for customer services. Also, in a usual method, customers tend to inform desired hairstyles and contents to stylists and councilors by making use of limited data sources such as magazines and cut-offs. In such a method, it is difficult for the customers to accurately inform their own intents to the stylists or councilors.

Hair processing spots have been collecting always changing fashionable hairstyles from magazines and like data sources. However, it is necessary to collect data on the basis of many different kinds and numbers of magazines. Also, since such data sources cause contamination, their storage and management for providing for convenience when they are referred to are cumbersome.

Because of such affairs, systems have been proposed, which are used for the convenience of communication between the hair processing spot and the customer side.

For example, a device has been proposed, in which the video of a television camera provided on a unit for confirming the customer's hairstyle and the video accumulated in an IC card are displayed on a video monitor having a flat mirror at the front for comparing these video displays and confirming the result (Literature 1: Japanese Utility Model Laid-Open Hei 3-092881).

Also, a hairstyle managing device has been proposed, in which video of a television camera and a video accumulated in an IC card are displayed on a video monitor having a flat mirror on the front for comparison of these displays and confirming the result, while also data for paying a hair-dressing charge on the video monitor (Literature 2: Japanese Utility Model Laid-Open Hei 4-021318).

Furthermore, a hair-dressing air-cutting combined hairstyle system to be used in beauty parlors and barber shops has been proposed, which comprises a picture taking means for taking picture of the customer's head, a hairstyle storing means for storing a plurality of different hairstyles, and a face style/hairstyle combining means for combining hairstyles stored in the hairstyle storing means, for checking a desired hairstyle is fitting before changing the hairstyle (Literature 3: Japanese Patent Laid-Open 2000-231318).

Still further, customer data comprising system and method for hair processing spots has been proposed, which has a purpose of permitting readily hair-dressing of the customer for desired hairstyle forming and receiving satisfactory services by utilizing a nearby hair processing spot in the case of having idle time or utilizing a site hair processing spot in the place of dispatch or trip with commonization of the customer data in hair processing spots. To this end, terminal units installed in hair processing spots and a server unit for storing and supplying customer data are connected via a communication network for communication with one another. The terminal units each include a transmitting means for transmitting at least customer's hairstyle pick-up data together with ID data of the customers to the server unit, and the server unit includes a storing means for storing received pick-up data in relation to ID data and a transmitting means for transmitting pick-up data corresponding to ID data to terminal units in response to a request based on customer's ID data from the terminal unit (Literature 4: Japanese Patent Laid-Open 2001-344336).

Yet further, it has been proposed that a customer synthesizes, processes and designs a hairstyle to suit his or her own taste on the basis of the hairstyles, hair colors and decorations/garments in a hair processing root terminal by using a user terminal and transmits the hairstyle to the hair processing spot terminal, a hair dressing spot terminal sends out data of products out of stock and those necessary for styling to terminals in sales shops and rental shops via internet with reference to necessary product stock data, does scheduling by registering preservation data in a customer database in the hair processing spot and sends back the produced data to a user terminal, and the customer receives in the scheduled day the styling by a stylist in the hair processing spot on the basis of the order data designed in advance by himself or herself (Literature 5: Japanese Patent Laid-Open 2002-197330).

Further, it has been proposed to realize a customer managing system in a hair processing spot, in which a customer can select a desired hairstyle among past hairstyles, with data necessary for the styling recorded in a member's card. In this proposal, a customer records all data in a card carried by himself or herself, and the spot side reads out the data from the card with a card reader/writer and displays the read-out data on the CRT display. Thus, the hairstyle history can be displayed. The hairstyle formed this time is picked up with a CCD camera, and additionally recorded in the card (Literature 6: Japanese Patent Laid-Open Hei 5-040858).

Further, a device has been proposed, in which in a hair processing spot a desired hairstyle is made selectable by progressively fitting a plurality of preliminarily prepared hairstyle images (Literature 7: Japanese Utility Model Laid-Open Showa 57-045813).

Further, a product sales registration data processing device has been proposed, in which in case when image data of a customer buying a product outputted from a pick-up means had been certified at a predetermined timing in an image certifying means at the time announcement of a sales registration process accompanying the sales of the product by an end announcing means, certified image data of the customer who bought the product, is printed together with sales data based on sales amount process and a mark specifying the place of purchase on a printing sheet, which is issued as a receipt (Literature 8: Japanese Patent Laid-Open 2001-118148). It is said that, with this device, it is possible to issue a characteristic receipt which may remain in memory in such a manner that the characteristic receipt remaining in memory is printed in this device together with a mark specifying the place of purchase and a figure of the customer (i.e., certified image data).

Further, it has been proposed that after transaction contents have been printed in a POS terminal unit on the basis of inputted transaction data, a receipt, in which the introduction of the operator is printed together with his or her face image, is issued, thereby providing familiarity to the customer, giving the customer an image of a spot to readily become intimate with, obtaining steadily visiting customers and improving the sales.

However, even with any of the above proposed techniques, a sufficient function may not be provided for permitting counseling with enriched contents and freedom from care to be obtained by confirming the hairstyle and various relevant data from display panels directed to both of a stylist or a councilor and the customer present face to face in a hair processing spot.

### SUMMARY OF THE INVENTION

An object of the present invention, accordingly, is to provide data managing systems and methods, in which a hair processing spot with enriched contents and customer's freedom from care such that a stylist or a councilor in a hair processing spot and the customer are adapted to face each other and confirm the hairstyle and various relevant data from displays directed to both of them, respectively, thus providing in advance for counseling with enriched contents and customer's freedom from care.

According to an aspect of the present invention, there is provided a data managing system for a hair processing spot comprising a data terminal unit including a display/operation panel having at least two touch panels, one being a first display/operation panel disposed to be visible and readily operable from the operator side, the other being a second display/operation panel disposed to be visible and readily operable from the customer side, and a storing unit including a database capable of being accessed from the data terminal unit, wherein: the data terminal unit is arranged to cause display, on the second display/operation panel, of data concerning predetermined items scheduled to be visually recognized from the customer side, among data inputted, retrieved for or obtained on the basis of a predetermined operation on the first display/operation panel.

At least two units are provided as the data terminal units, one of the units serving as an accepting terminal used for data input for the first accepting or accounting business of a customer visiting a hair processing spot, another one of the units serving as a counseling terminal used for doing counseling with respect to the customer.

The accepting terminal includes a storing unit internally having the database. The accepting terminal includes a storing unit having the database and accessibly connected to its own outside. The database holds software for executing accepting and accounting or like business after the end of service and accumulations of data for customer service and accepting processes and hairstyle catalogue data. The counseling terminal is arranged to be capable of accessing the data for the customer service and accepting processes and the hairstyle catalogue data held in the database. The accepting terminal is arranged to produce a customer account from data, which is inputted on the basis of a predetermined operation on the first display/operation panel and representing a particular customer registered in the hair processing unit, and assign a peculiar customer ID to the customer. The accepting terminal includes a card issuing function unit for issuing a customer card, in which the customer account data and customer ID data and also data for determining these data are stored. The accepting terminal includes a card reader function unit for reading out data stored in a customer card, in which the customer account data and customer ID data and also data for determining these data are stored.

The accepting terminal obtains image data of the customer's hairstyle before the setting as picked up by a digital camera capable of supplying image data to it on the basis of a predetermined operation on the first display/operation panel in the accepting terminal and displays the image of the customer's hair before the setting based on the obtained data on both the first and second display/operation panels.

The accepting terminal is arranged to automatically calculate the predicted waiting time on the basis of data representing the customer's desired service contents for the pertinent way, such as designated operator in charge and cut and permanent wave, and data accumulated in the database and representing number of customers in charge of the designated stylist or councilor, desired service contents, etc. and display the predicted waiting time on both the first and second display/operation panels.

The counseling terminal is arranged such that it can display the spot-visiting history of the pertinent customer on the first display/operation panel. The display modes of a list display, i.e., sequential list-wise display, of the spot-visiting history as the above spot-visiting history, and detail display representing details of the service contents concerning a particular spot-visiting day in the list, are obtainable step-wise.

The counseling terminal is arranged such that it can start the retrieval for a hairstyle, which conforms to conditions determined by inputting the customer's present hairstyle and desire on the first display/operation panel in face-to-face relation to the customer, from a hairstyle catalogue database in the database on the basis of an operation with respect to a predetermined display on the first display/operation panel and display a plurality of hairstyle images obtained as a result of retrieval on the second display/operation panel.

The counseling terminal is arranged such that it can display the image of a hairstyle, determined on the basis of a customer's operation on the second display/operation panel, among the plurality of hairstyle images displayed on the second display/operation panel, and input data concerning necessary services on the basis of an operator's operation on the first display/operation panel with the pertinent hairstyle image displayed thereon.

The counseling terminal is arranged such that it preserves data representing the retrieval conditions applied for the hairstyle retrieval, the selected hairstyle, the certified service, etc. in the database. The accepting terminal is arranged such that it obtains, on the basis of a Predetermined operation on the first display/operation panel in the accepting terminal, customer's hairstyle data after the setting, picked up with a digital camera disposed such as to be capable of supplying image data to it, and displays the customer's hairstyle image after the setting, based on the obtained image data, together with a previously obtained hairstyle image before the setting on both the first and second display/operation panels.

The accepting terminal is arranged such that it obtains, on the basis of a Predetermined operation on the first display/operation panel in the accepting terminal, customer's hairstyle data after the setting, picked up with a digital camera disposed such as to be capable of supplying image data to it, and displays the customer's hairstyle image after the setting, based on the obtained image data, together with a previously obtained hairstyle image before the setting on both the first and second display/operation panels, and prints, on the basis of a predetermined operation on the first display/operation panel, the customer's hairstyle image after the setting based on the obtained image data on a predetermined area of a receipt to be issued to the customer in a printer for receipt printing.

The counseling terminal has an internet connecting function permitting down-loading of hairstyle catalogue data through internet. The accepting terminal is arranged such that a customer ID preliminarily assigned as peculiar ID to the customer on the basis of a customer's operation with respect to the second display/operation panel.

According to another aspect of the present invention, there is provided a data managing method for hair processing spots comprising the steps of providing a data terminal unit having a first display/operation panel constituted by a touch panel disposed to be visible and readily operable from the operator side and a second display/operation panel constituted by a touch panel disposed to be visible and readily operable from the customer side, providing a storing unit having a database and capable of being accessed from the data terminal unit, and causing a display, on the second display/operation panel, of data concerning predetermined items scheduled to be visually recognized from the customer side, among data inputted, retrieved for or obtained on the basis of a predetermined operation on the first display/operation panel, thereby permitting the operator side and the customer side to exchange data in face-to-face relation to each other via the first and second display/operation panels.

At least two units are provided as the data terminal units, one of the units serving as an accepting terminal used for data input for the first accepting or accounting business of a customer visiting a hair processing spot, another one of the units serving as a counseling terminal used for doing counseling with respect to the customer. The accepting terminal includes a storing unit internally having the database. The accepting terminal includes a storing unit having the database and accessibly connected to its own outside. The database holds software for executing accepting and accounting or like business after the end of service and accumulations of data for customer service and accepting processes and hairstyle catalogue data. The counseling terminal is arranged to be capable of accessing the data for the customer service and accepting processes and the hairstyle catalogue data held in the database. The accepting terminal is arranged to produce a customer account from data, which is inputted on the basis of a predetermined operation on the first display/operation panel and representing a particular customer registered in the hair processing unit, and assign a peculiar customer ID to the customer.

The accepting terminal includes a card issuing function unit for issuing a customer card, in which the customer account data and customer ID data and also data for determining these data are stored. The accepting terminal includes a card reader function unit for reading out data stored in a customer card, in which the customer account data and customer ID data and also data for determining these data are stored. The accepting terminal obtains image data of the customer's hairstyle before the setting as picked up by a digital camera capable of supplying image data to it on the basis of a predetermined operation on the first display/operation panel in the accepting terminal and displays the image of the customer's hair before the setting based on the obtained data on both the first and second display/operation panels.

The accepting terminal is arranged to automatically calculate the predicted waiting time on the basis of data representing the customer's desired service contents for the pertinent way, such as designated operator in charge and cut and permanent wave, and data accumulated in the database and representing number of customers in charge of the designated stylist or councilor, desired service contents, etc. and display the predicted waiting time on both the first and second display/operation panels. The counseling terminal is arranged such that it can display the spot-visiting history of the pertinent customer on the first display/operation panel. The display modes of a list display, i.e., sequential list-wise display, of the spot-visiting history as the above spot-visiting history, and detail display representing details of the service contents concerning a particular spot-visiting day in the list, are obtainable step-wise.

The counseling terminal is arranged such that it can start the retrieval for a hairstyle, which conforms to conditions determined by inputting the customer's present hairstyle and desire on the first display/operation panel in face-to-face relation to the customer, from a hairstyle catalogue database in the database on the basis of an operation with respect to a predetermined display on the first display/operation panel and display a plurality of hairstyle images obtained as a result of retrieval on the second display/operation panel. The counseling terminal is arranged such that it can display the image of a hairstyle, determined on the basis of a customer's operation on the second display/operation panel, among the plurality of hairstyle images displayed on the second display/operation panel, and input data concerning necessary services on the basis of an operator's operation on the first display/operation panel with the pertinent hairstyle image displayed thereon. The counseling terminal is arranged such that it preserves data representing the retrieval conditions applied for the hairstyle retrieval, the selected hairstyle, the certified service, etc. in the database.

The accepting terminal is arranged such that it obtains, on the basis of a Predetermined operation on the first display/operation panel in the accepting terminal, customer's hairstyle data after the setting, picked up with a digital camera disposed such as to be capable of supplying image data to it, and displays the customer's hairstyle image after the setting, based on the obtained image data, together with a previously obtained hairstyle image before the setting on both the first and second display/operation panels.

The accepting terminal is arranged such that it obtains, on the basis of a Predetermined operation on the first display/operation panel in the accepting terminal, customer's hairstyle data after the setting, picked up with a digital camera disposed such as to be capable of supplying image data to it, and displays the customer's hairstyle image after the setting, based on the obtained image data, together with a previously obtained hairstyle image before the setting on both the first and second display/operation panels, and prints, on the basis of a predetermined operation on the first display/operation panel, the customer's hairstyle image after the setting based on the obtained image data on a predetermined area of a receipt to be issued to the customer in a printer for receipt printing.

The counseling terminal has an internet connecting function permitting down-loading of hairstyle catalogue data through internet. The accepting terminal is arranged such that a customer ID preliminarily assigned as peculiar ID to the customer on the basis of a customer's operation with respect to the second display/operation panel.

Other objects and features will be clarified from the following description with reference to attached drawings.

### BRIEF DESCRIPTION OF THE DRAWINGS

FIG. 1 is a schematic view for describing data managing system and method for hair processing spots embodying the present invention;

FIG. 2 is a flow chart representing an accepting business when a customer visits the hair processing spot;

FIG. 3 is a flow chart showing the procedure of counseling;

FIG. 4 is a flow chart representing the routine of an accounting process executed in the accepting terminal 10;

FIGS. 5(A) and 5(B) are views showing an example of display status in the above customer registration in the two-touch-panel LCD unit in the accepting terminal 10;

FIGS. 6(A) and 6(B) are views showing an example of display status of the two-touch-panel LCD unit in the accepting terminal 10 in the above accepting procedure;

FIGS. 7(A) and 7(B) are view showing an example of the display status of the two-touch-panel LCD unit in the counseling terminal 20 during the counseling;

FIG. 8 is a view showing an example of the display status of the display panel, directed to the operator side, in the two-touch-panel LCD unit in the counseling terminal 20 in the initial stage of the counseling;

FIG. 9 is a view showing a further example of the display status of the display panel in the counseling terminal 20 in the case of confirming details of the spot-visiting history on the basis of the display of the spot-visiting history list shown in FIG. 8;

FIGS. 10(A) and 10(B) are views showing an example of the display status of the two-touch-panel LCD unit in the counseling terminal 20 when certifying the service of the day; and

FIGS. 11(A) and 11(B) are views showing an example of the display status of the two-touch-panel LCD unit in the accepting terminal 10 in the course of the accounting process.

### PREFERRED EMBODIMENTS OF THE INVENTION

Preferred embodiments of the present invention will now be described with reference to the drawings.

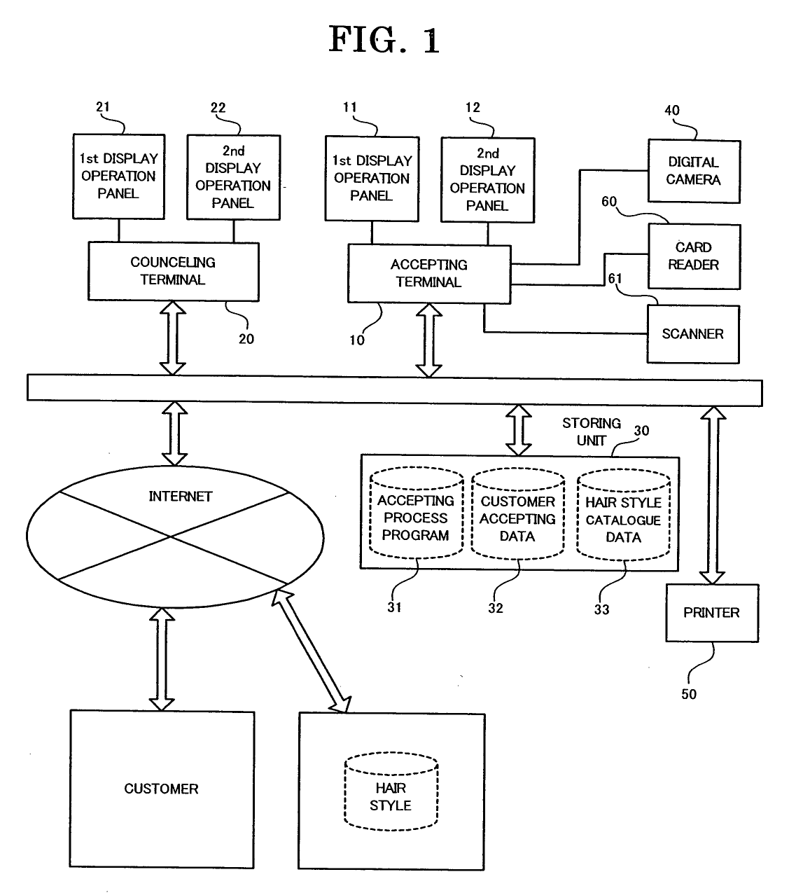

FIG. 1 is a schematic view for describing data managing system and method for hair processing spots embodying the present invention.

Referring to FIG. 1, this data managing system for hair processing spots comprises two data terminal units, one functioning as an accepting terminal 10, which is used for inputting data for accepting a customer visiting a hair dressing spot or for accounting business, and the other functioning as a counseling terminal 20, which is used for counseling provided to the customer. The data terminal units 10 and 20 each have a display/operation panel, which is constituted by at least two touch panels, i.e., a first display/operation panel 11 or 21 disposed to be visible and readily operable from the side of an operator, who may be an accepting clerk or a stylist in the hair processing spot, and a second display/operation panel 12 or 22 visible and readily operable from the side of the customer. The system further comprises a storing unit 30 having a database accessible from the terminals 10 and 20.

The accepting and counseling terminals 10 and 20 are arranged to display, on the second display/operation panels 12 and 22, respectively, data, which concerns an item scheduled to be visually recognized from the customer's side, among data having been inputted or retrieved for or obtained on the basis of operator's predetermined operations on the first display/operation panels 11 and 21, respectively.

The storing unit 30 accommodates software 31 for such database-wise business as accepting and accounting after the end of service, data 32 of processes of dealing with and accepting the customer and hairstyle catalogue data 33. Such storing unit 30 may be provided in the accepting terminal 10 or connected to the outside of the accepting terminal 10 such as to be able to access the same.

The counseling terminal 20 is arranged to be able to access the database for the customer dealing and accepting process data 31 and the hairstyle catalogue data 33 held in the database.

According to the present invention, in a hair processing spot, a two-touch-panel data processing terminal is provided as well as the accepting terminal 10 and a digital camera 40 adapted to be able to exchange picked-up image data, for preserving picture images in the database and providing more sophisticated services. The customer can review the hairstyle history on the panel and also quickly and accurately transfer his or her liked hairstyle, which is selected from the panel among samples preserved in the database by selection, to the stylist or councilor. Also, the hair processing spot side can collect customer data in greater details for providing counseling or promotion in such a manner as to suit the customer. Furthermore, in magazine publishers and chain store headquarters issuing hairstyle catalogues directed to hair processing spots, can distribute hairstyle catalogue data as new business.

A customer first visiting the spot executes customer registration in the accepting terminal 10. The accepting clerk on the hair processing spot side produces a customer account by inputting the name, address, age, occupation, mail address, etc. as customer data from the accepting terminal 10. To the customer, a customer ID is assigned, and a customer card such as a magnetic card or an IC card is issued from a card reader/writer 60. The customer becomes acceptable as soon as he or she completes the customer registration. When the customer shows the IC card at the accepting desk, the card is registered in the card reader/writer 60 or scanner 61, and the customer data is retrieved. A customer's picture is taken with the digital camera 40, which is provided such as to be able to supply image data to the accepting terminal 10.

At his or her turn, the customer gets into counseling with the stylist or councilor. In the counseling terminal 20, the stylist or councilor takes out the customer data on the basis of the customer ID, and provides a hairstyle suited to the customer by filtering out conditions taken out from the hairstyle catalogue database on the basis of the hair history, present hairstyle and customer's desire.

After the end of the setting, the hair processing spot effects accounting and also takes again a picture of the customer after setting in the accepting terminal. The hair processing spot can appeal the effect of setting to the customer by displaying pictures before and after the setting on the customer side panel. It is also possible to print out a receipt with pictures impressed thereon by connecting a printer 50 capable of printing pictures to the receiving terminal 10. Furthermore, the hair processing spot can automatically produce spot visiting question lists or direct mails in the accepting terminal 10 from customer data and spot visiting data (such as pictures, stylist in charge and cut data) in the customer database and send out these question lists or mails. Still further, since stylist's result management is obtainable from pictures, it is possible to provide more sophisticated instructions. Yet further, the hairstyle database provides new business possibility by selling data to hair processing spots, magazine publishers, beauty parlor chain headquarters, stylist schools, etc. via internet, CD-ROM, etc.

Moreover, it is possible to construct the accepting and counseling terminals 10 and 20 to be integral with each other or profile additional terminals in dependence on the store scale of the hair processing spot adopting the present system. As for the accepting and counseling terminals 10 and 20, in order to be able to provide for sufficient convenience when showing pictures to the customer or providing a conversation type service such as counseling, a data processing terminal having two-touch-panel LCD units as described before is applied. To the accepting terminal 10 as data processing terminal with a touch panel unit, are connected such peripheral devices necessary for the business as a keyboard (not shown) for inputting customer data, the card reader/writer 60 and/or the scanner 61 for customer card read-in and the digital camera 40 for taking customer's pictures. The system further has an internet connecting function to enable customer promotion with electronic mails and down-loading of hairstyle catalogue data via internet.

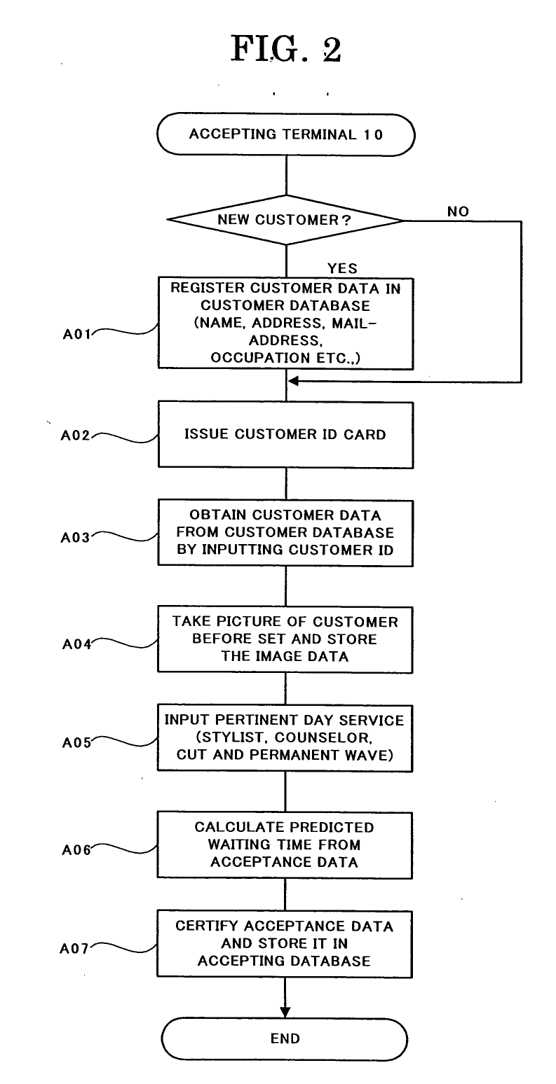

The operation of the embodiment will now be described in detail with reference to FIGS. 2 to 11. FIG. 2 is a flow chart representing an accepting business when a customer visits the hair processing spot. The customer visiting the spot goes to an accepting locality with the accepting terminal 10 installed thereon. As shown in FIG. 2, a customer first visiting the spot does customer registration. An accepting clerk on the spot side obtains necessary data such as name, address, age, occupation and mail address, and inputs the obtained data to the accepting terminal 10 with the keyboard and touch panel (step A01).

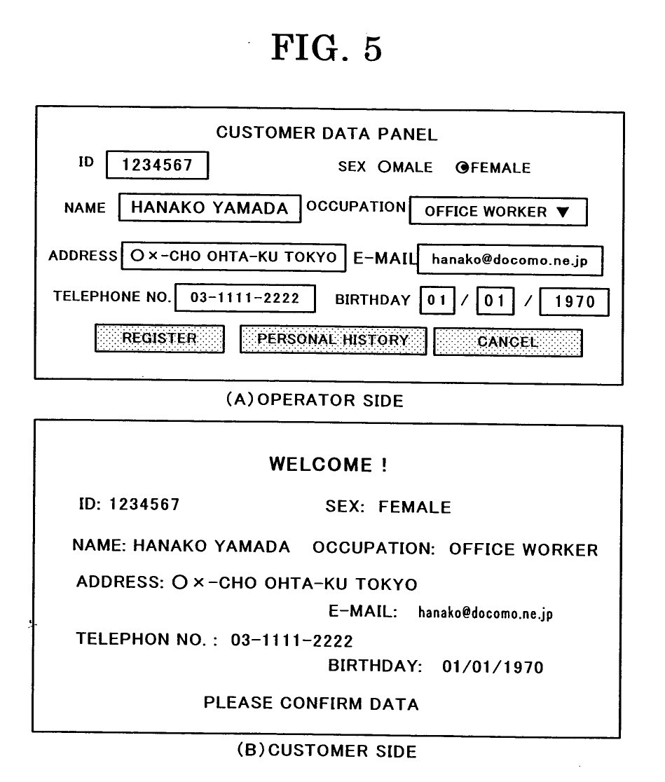

FIGS. 5(A) and 5(B) are views showing an example of display status in the above customer registration in the two-touch-panel LCD unit in the accepting terminal 10.

FIG. 5(A) illustrates the display panel directed to the side of the operator in the spot (i.e., first display/operation panel 11). FIG. 5(B) shows the display panel directed to the customer side (i.e., second display/operation panel 12). This arrangement is arranged such that among data inputted or retrieved for or obtained on the basis of a predetermined operation done on the first display/operation panel 11, which is disposed to be readily visible and operable from the operator side, data concerning predetermined items programmed to be visually recognized from the customer side, are displayed on the second display/operation panel 12 which is disposed to be readily visible and operable from the customer side. The customer side thus can immediately confirm the status of input from the operator side and prevent erroneous input.

When a customer account is produced as data representing a particular customer registered in this spot in the above way, a unique customer ID is allotted to the customer. Then a customer card, in which the data of the customer account and customer ID data or data representing these data, is issued from the card reader/writer 60, which is a card issuing function unit operable from the accepting terminal 11, in such form as a magnetic card, an IC card, as card with a bar code or a card with printed number (step A02).

A customer who has completed the customer registration or has already been registered executes an accepting process. The customer delivers the customer card to the accepting clerk in the spot. The accepting clerk inputs the customer ID to the accepting terminal 10 in a method conforming to the form of the customer card. In the case that the form of the customer card is the magnetic card or the IC card, the accepting clerk executes the input by using the card reader, in the case that the card form is the card with a bar code, he or she executes the input by using the card scanner, and in the case that the card form is the card with printed number, he or she executes the input by using the keyboard. After the operator (i.e., accepting clerk) has done the input, he or she retrieves the customer database (step A03).

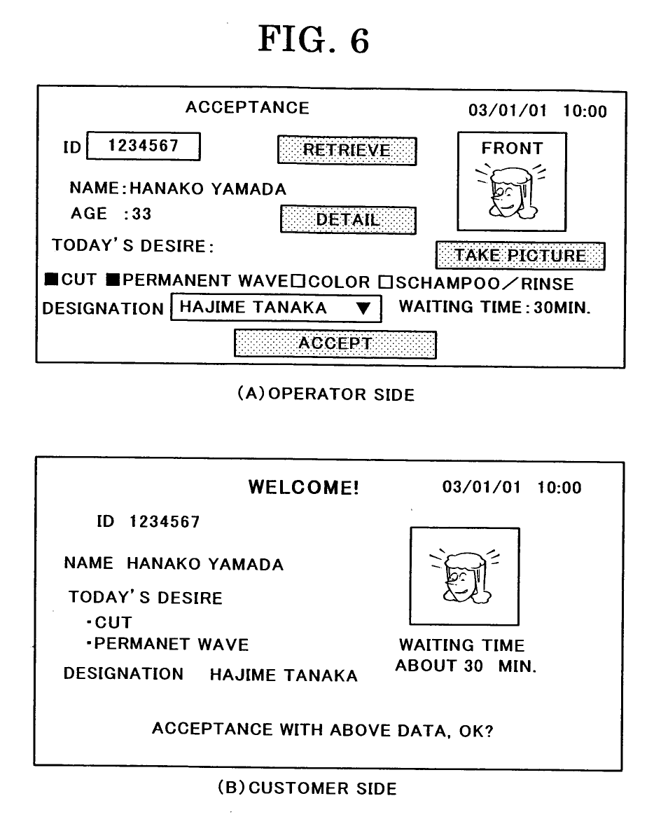

FIGS. 6(A) and 6(B) are views showing an example of display status of the two-touch-panel LCD unit in the accepting terminal 10 in the above accepting procedure. FIG. 6(A) shows the display panel directed to the operator side in the spot in the accepting procedure. FIG. 6(B) shows the display panel directed to the customer side. When pertinent customer data has been found as a result of the above retrieval, the customer data are displayed on the panels as shown in FIGS. 6(A) and 6(B).

The accepting clerk then takes a picture of the customer before the setting with the digital camera 40, which is provided to be able to function as a unit for inputting data to the accepting terminal 10, and takes out image data with a clearly picked-up hairstyle of the customer from the digital camera 40 by depressing a pick-up button in the display panel (i.e., touching a pertinent display on the touch panel) directed to the operator side (step A04). The obtained image data is displayed on the panels on both the operator and customer sides. The accepting clerk then confirms the desired service contents of the pertinent day, such as the designated stylist or councilor, cut and permanent wave, from the customer, and inputs these data to the accepting terminal 10 (step A05).

In this system, the predicted waiting time is automatically calculated and displayed on the basis of the numbers of customers in charge of individual stylists and/or councilors, contents of individual services, etc. by using the accepting terminal 10, the database noted above, etc. (step A06). Thus, the customer can grasp in advance and depending on the situation that he or she can agree with the waiting time, and it is possible to provide a system providing for enhanced degree of satisfaction. When the customer agrees with the waiting time, the accepting is certified, and the input data are preserved in the accepting database (step A07).

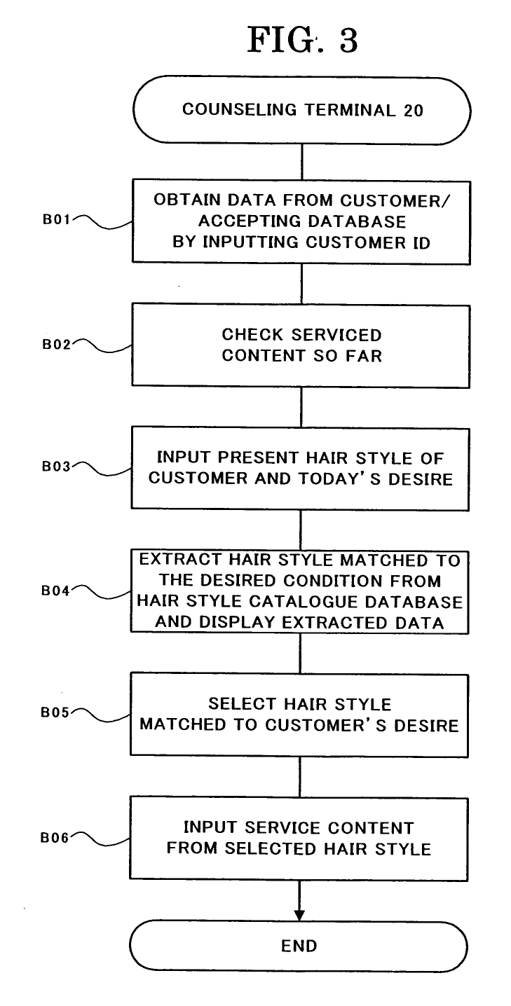

When the turn of the customer comes up, he or she does counseling with the stylist or councilor. FIG. 3 is a flowchart showing the procedure of counseling. As shown in FIG. 3, the stylist or councilor inputs the above customer ID to the counseling terminal 20, and takes out the customer data and the desired service contents of the day from the customer and accepting databases (step B01).

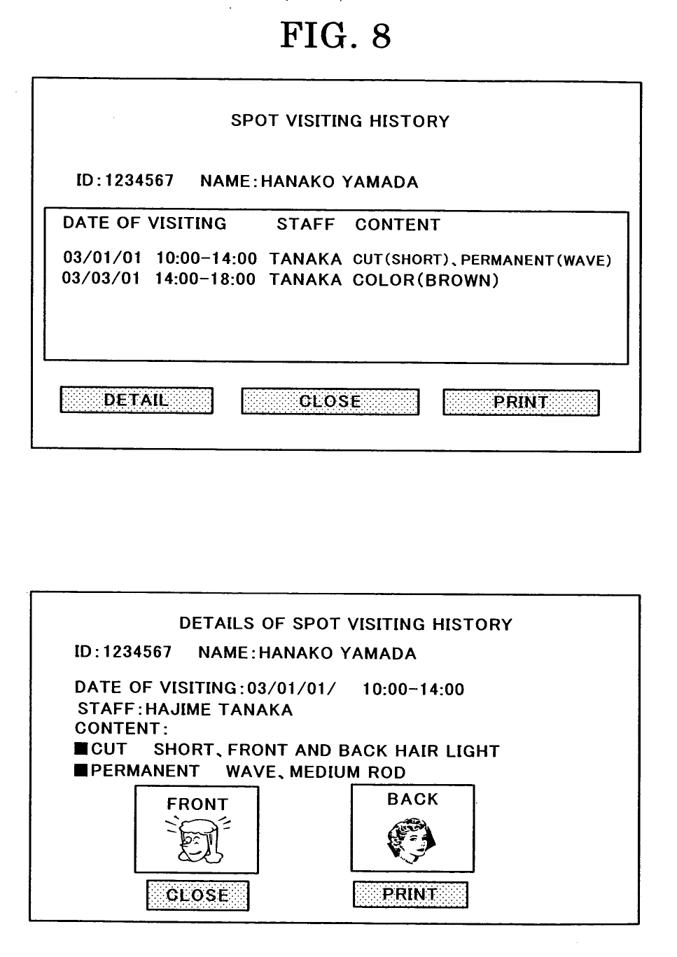

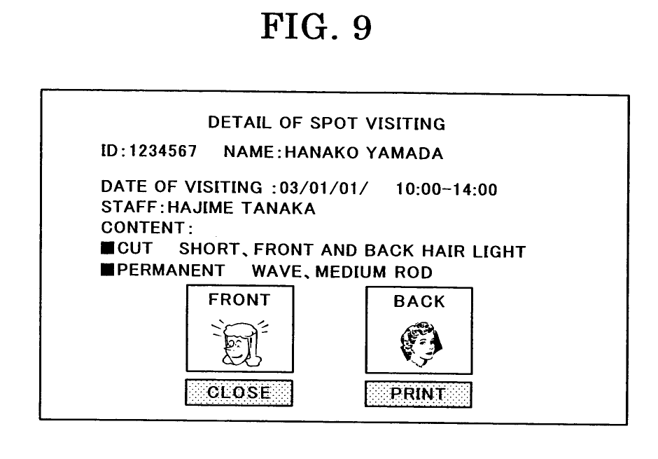

The stylist or councilor checks the service contents so far the customer's satisfaction level, etc. from the spot-visiting history, and collects data for starting the counseling (step B02). FIG. 8 is a view showing an example of the display status of the display panel, directed to the operator side, in the two-touch-panel LCD unit in the counseling terminal 20 in the initial stage of the counseling. FIG. 9 is a view showing a further example of the display status of the display panel in the counseling terminal 20 in the case of confirming details of the spot-visiting history on the basis of the display of the spot-visiting history list shown in FIG. 8.

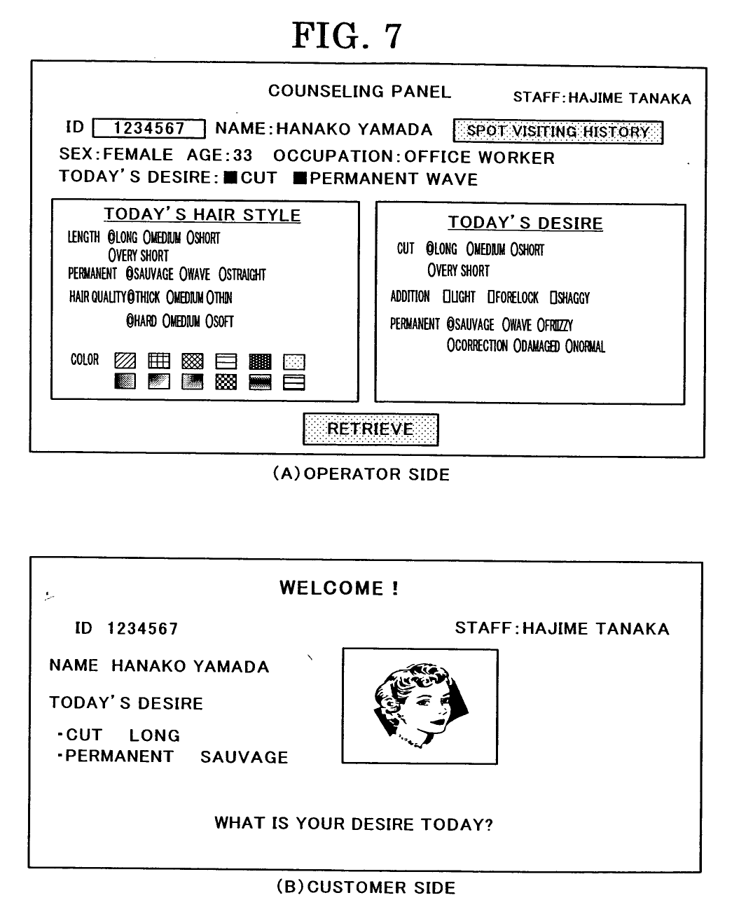

FIGS. 7(A) and 7(B) are view showing an example of the display status of the two-touch-panel LCD unit in the counseling terminal 20 during the above counseling. FIGS. 7(A) and (B) show a display on the operator side of the spot for the acceptance and a display on the customer side thereof. As is exemplified in these Figures, the operator inputs the present hairstyle and desire of the customer while conversing with the customer (step B03). When conditions have been determined, the operator depresses a retrieval button (i.e., touches a pertinent ICON display on the touch panel). As a result, the system retrieves the hairstyle matched to the conditions from the hairstyle catalogue data, and displays the pertinent data on the panel (step B04).

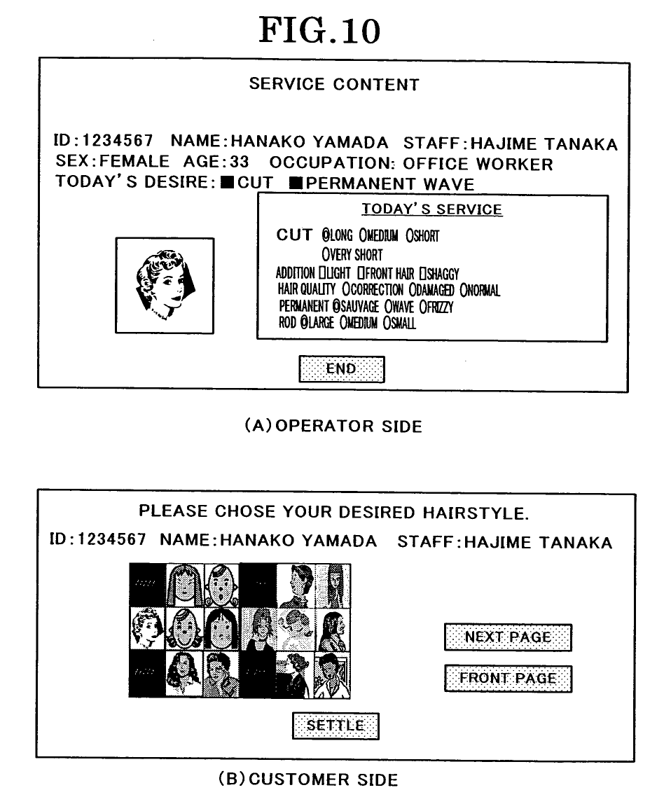

FIGS. 10(A) and 10(B) are views showing an example of the display status of the two-touch-panel LCD unit in the counseling terminal 20 when certifying the service of the day. FIG. 10(A) shows the display panel directed to the operator side in the spot in the accepting procedure. FIG. 10(B) shows the display panel directed to the customer side. The customer selects a desired hairstyle among the displayed hairstyles (step B05). The stylist or councilor inputs necessary service data by observing the desired hairstyle, thus ending the counseling (step B06).

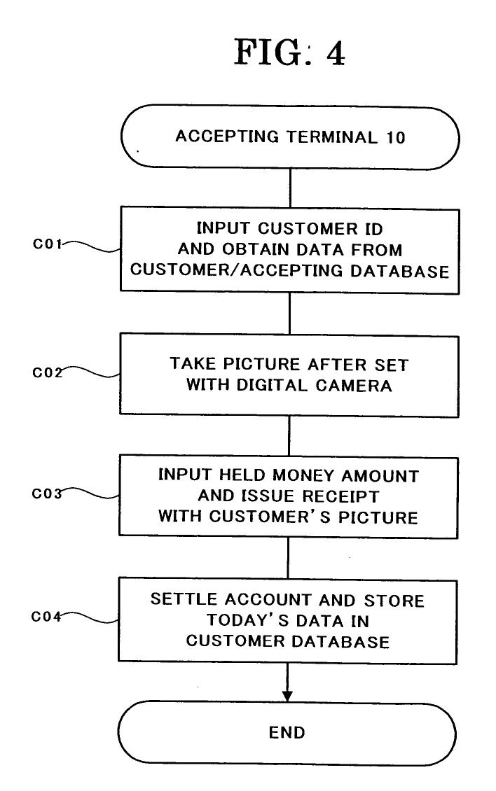

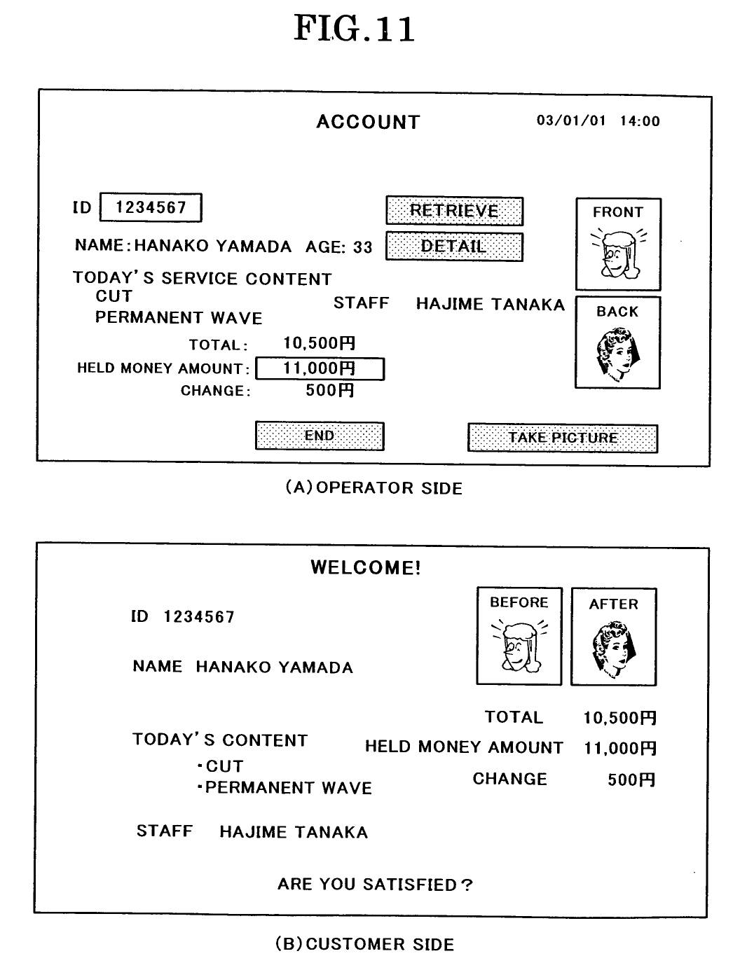

The data of the used retrieval conditions, selected hairstyle, certified services, etc. are preserved in the above database provided in the accepting terminal 10. After the end of the setting, the customer executes an accounting process at the accounting site. FIG. 4 is a flow chart representing the routine of an accounting process executed in the accepting terminal 10. The accepting clerk inputs the customer ID in the accepting terminal 10, obtains data from the customer and accepting database, and causes display of the sum calculated from the service contents (step C01). FIGS., 11(A) and 11(B) are views showing an example of the display status of the two-touch-panel LCD unit in the accepting terminal 10 in the course of the accounting process. FIG. 11(A) shows the display panel directed to be operator side in the spot in the accepting procedure. FIG. 11(B) shows the display panel directed to the customer side.

When the accepting clerk or the stylist or councilor has taken a customer's picture after the setting with the digital camera, he or she obtains image data containing a clear picture of the customer's hairstyle by depressing the pick-up button (i.e., touching the pertinent display on the touch panel (step C02). It is also possible that the operator receives the supply of hairstyle data of the customer after the setting from the accepting terminal 10, then inputs a held money amount by using the printer 10 capable of printing pictures, and then print a receipt with a customer's picture printed thereon. The hair dressing spot can automatically produce question forms of spot-visiting enquete and direct mails from customer data and spot-visiting data (i.e., pictures, stylist or councilor in charge and cut data) of the customer database and send out these forms and mails. In this way, it is possible to expect service improvement and sales increase. Furthermore, it is possible to manage the results of the stylists and councilors from the customer's pictures, thus providing for more sophisticated technical instructions.

With magazines or the like, it has been very difficult to search a hairstyle desired by the customer in a range of selection from the present hair state of the customer (i.e., length, quality, shape, etc. of the hair). In the above embodiment, such search can be done simply and quickly. Also, by providing hairstyle catalogues in on-line provision, a convenience is obtainable that no magazine need be purchased or managed. Furthermore, since customer data containing pictures are obtainable, it is possible to effectively make evaluation of the customer's satisfaction level, promotion fitted to customer's needs and improvement of the techniques of the stylists and councilors.

Moreover, by displaying customer's pictures before and after the setting (of the time and preceding time), it is possible to expect that customers highly evaluate the quality of the hair processing spot.

A different embodiment of the present invention will now be described. This embodiment is a system, in which self-services are introduced in order to simplify the operation on the spot side and reduce cost. Specifically, the accepting procedure is automated by using the display panel (first display/operation display 11) directed to the customer side in the accepting terminal. A customer visiting the spot inputs his or her own customer ID from the display panel directed to the customer side in the accepting terminal, and also inputs such data as picture, service contents designation by himself or herself. According to these inputs, the customer confirms the waiting time displayed on the panel, and when the waiting time is agreeable, he or she registers the accepting.

A customer first visiting the spot is outside the subject because in this case it is necessary to input data. Since the customer inputs data by himself or herself, it is necessary to divide the display data on the panel directed to the operator side in the accepting terminal 10 as described before with reference to FIG. 6 in steps and display the data together with guidance to the customer side such as to be capable of being readily understood.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A data managing system for a hair processing spot comprising a data terminal unit including a display/operation panel having at least two touch panels, one being a first display/operation panel disposed to be visible and readily operable from the operator side, the other being a second display/operation panel disposed to be visible and readily operable from the customer side, and a storing unit including a database capable of being accessed from the data terminal unit, wherein:
the data terminal unit is arranged to cause display, on the second display/operation panel, of data concerning predetermined items scheduled to be visually recognized from the customer side, among data inputted, retrieved for or obtained on the basis of a predetermined operation on the first display/operation panel.

2. The data managing system for hair processing spots according to claim 1, wherein at least two units are provided as the data terminal units, one of the units serving as an accepting terminal used for data input for the first accepting or accounting business of a customer visiting a hair processing spot, another one of the units serving as a counseling terminal used for doing counseling with respect to the customer.

3. The data managing system for hair processing spots according to claim 2, wherein the accepting terminal includes a storing unit internally having the database.

4. The data managing system for hair processing spots according to claim 2, wherein the accepting terminal includes a storing unit having the database and accessibly connected to its own outside.

5. The data managing system for hair processing spots according to one of claims 3 and 4, wherein the database holds software for executing accepting and accounting or like business after the end of service and accumulations of data for customer service and accepting processes and hairstyle catalogue data.

6. The data managing system for hair processing spots according to claim 2, wherein the counseling terminal is arranged to be capable of accessing the data for the customer service and accepting processes and the hairstyle catalogue data held in the database.

7. The data managing system for hair processing spots according to claim 2, wherein the accepting terminal is arranged to produce a customer account from data, which is inputted on the basis of a predetermined operation on the first display/operation panel and representing a particular customer registered in the hair processing unit, and assign a peculiar customer ID to the customer.

8. The data managing system for air processing spots according to claim 2, wherein the accepting terminal includes a card issuing function unit for issuing a customer card, in which the customer account data and customer ID data and also data for determining these data are stored.

9. The data managing system for hair processing spots according to claim 2, wherein the accepting terminal includes a card reader function unit for reading out data stored in a customer card, in which the customer account data and customer ID data and also data for determining these data are stored.

10. The data managing system for hair processing spots according to claim 2, wherein the accepting terminal obtains image data of the customer's hairstyle before the setting as picked up by a digital camera capable of supplying image data to it on the basis of a predetermined operation on the first display/operation panel in the accepting terminal and displays the image of the customer's hair before the setting based on the obtained data on both the first and second display/operation panels.

11. The data managing system for hair processing spots according to claim 2, wherein the accepting terminal is arranged to automatically calculate the predicted waiting time on the basis of data representing the customer's desired service contents for the pertinent way, such as designated operator in charge and cut and permanent wave, and data accumulated in the database and representing number of customers in charge of the designated stylist or councilor, desired service contents, etc. and display the predicted waiting time on both the first and second display/operation panels.

12. The data managing system for hair processing spots according to claim 2, wherein the counseling terminal is arranged such that it can display the spot-visiting history of the pertinent customer on the first display/operation panel.

13. The data managing system for hair processing sots according to claim 12, wherein the display modes of a list display, i.e., sequential list-wise display, of the spot-visiting history as the above spot-visiting history, and detail display representing details of the service contents concerning a particular spot-visiting day in the list, are obtainable step-wise.

14. The data managing system for hair processing spots according to claim 2, wherein the counseling terminal is arranged such that it can start the retrieval for a hairstyle, which conforms to conditions determined by inputting the customer's present hairstyle and desire on the first display/operation panel in face-to-face relation to the customer, from a hairstyle catalogue database in the database on the basis of an operation with respect to a predetermined display on the first display/operation panel and display a plurality of hairstyle images obtained as a result of retrieval on the second display/operation panel.

15. The data managing system for hair processing spots according to claim 14, wherein the counseling terminal is arranged such that it can display the image of a hairstyle, determined on the basis of a customer's operation on the second display/operation panel, among the plurality of hairstyle images displayed on the second display/operation panel, and input data concerning necessary services on the basis of an operator's operation on the first display/operation panel with the pertinent hairstyle image displayed thereon.

16. The data managing system for hair processing spots according to claim 15, wherein the counseling terminal is arranged such that it preserves data representing the retrieval conditions applied for the hairstyle retrieval, the selected hairstyle, the certified service, etc. in the database.

17. The data managing system for hair processing spots according to claim 2, wherein the accepting terminal is arranged such that it obtains, on the basis of a Predetermined operation on the first display/operation panel in the accepting terminal, customer's hairstyle data after the setting, picked up with a digital camera disposed such as to be capable of supplying image data to it, and displays the customer's hairstyle image after the setting, based on the obtained image data, together with a previously obtained hairstyle image before the setting on both the first and second display/operation panels.

18. The data managing system for hair processing spots according to claim 2, wherein the accepting terminal is arranged such that it obtains, on the basis of a Predetermined operation on the first display/operation panel in the accepting terminal, customer's hairstyle data after the setting, picked up with a digital camera disposed such as to be capable of supplying image data to it, and displays the customer's hairstyle image after the setting, based on the obtained image data, together with a previously obtained hairstyle image before the setting on both the first and second display/operation panels, and prints, on the basis of a predetermined operation on the first display/operation panel, the customer's hairstyle image after the setting based on the obtained image data on a predetermined area of a receipt to be issued to the customer in a printer for receipt printing.

19. The data managing system for hair processing spots according to claim 2, wherein the counseling terminal has an internet connecting function permitting down-loading of hairstyle catalogue data through internet.

20. The data managing system for hair processing spots according to claim 2, wherein the accepting terminal is arranged such that a customer ID preliminarily assigned as peculiar ID to the customer on the basis of a customer's operation with respect to the second display/operation panel.

21. A data managing method for hair processing spots comprising the steps of providing a data terminal unit having a first display/operation panel constituted by a touch panel disposed to be visible and readily operable from the operator side and a second display/operation panel constituted by a touch panel disposed to be visible and readily operable from the customer side, providing a storing unit having a database and capable of being accessed from the data terminal unit, and causing a display, on the second display/operation panel, of data concerning predetermined items scheduled to be visually recognized from the customer side, among data inputted, retrieved for or obtained on the basis of a predetermined operation on the first display/operation panel, thereby permitting the operator side and the customer side to exchange data in face-to-face relation to each other via the first and second display/operation panels.

22. The data managing method for hair processing spots according to claim 21, wherein at least two units are provided as the data terminal-units, one of the units serving as an accepting terminal used for data input for the first accepting or accounting business of a customer visiting a hair processing spot, another one of the units serving as a counseling terminal used for doing counseling with respect to the customer.

23. The data managing method for hair processing spots according to claim 22, wherein the accepting terminal includes a storing unit internally having the database.

24. The data managing method for hair processing spots according to claim 22, wherein the accepting terminal includes a storing unit having the database and accessibly connected to its own outside.

25. The data managing method for hair processing spots according to one of claims 23 and 24, wherein the database holds software for executing accepting and accounting or like business after the end of service and accumulations of data for customer service and accepting processes and hairstyle catalogue data.

26. The data managing method for hair processing spots according to claim 22, wherein the counseling terminal is arranged to be capable of accessing the data for the customer service and accepting processes and the hairstyle catalogue data held in the database.

27. The data managing method for hair processing spots according to claim 22, wherein the accepting terminal is arranged to produce a customer account from data, which is inputted on the basis of a predetermined operation on the first display/operation panel and representing a particular customer registered in the hair processing unit, and assign a peculiar customer ID to the customer.

28. The data managing method for air processing spots according to claim 22, wherein the accepting terminal includes a card issuing function unit for issuing a customer card, in which the customer account data and customer ID data and also data for determining these data are stored.

29. The data managing method for hair processing spots according to claim 22, wherein the accepting terminal includes a card reader function unit for reading out data stored in a customer card, in which the customer account data and customer ID data and also data for determining these data are stored.

30. The data managing method for hair processing spots according to claim 22, wherein the accepting terminal obtains image data of the customer's hairstyle before the setting as picked up by a digital camera capable of supplying image data to it on the basis of a predetermined operation on the first display/operation panel in the accepting terminal and displays the image of the customer's hair before the setting based on the obtained data on both the first and second display/operation panels.

31. The data managing method for hair processing spots according to claim 22, wherein the accepting terminal is arranged to automatically calculate the predicted waiting time on the basis of data representing the customer's desired service contents for the pertinent way, such as designated operator in charge and cut and permanent wave, and data accumulated in the database and representing number of customers in charge of the designated stylist or councilor, desired service contents, etc. and display the predicted waiting time on both the first and second display/operation panels.

32. The data managing method for hair processing spots according to claim 22, wherein the counseling terminal is arranged such that it can display the spot-visiting history of the pertinent customer on the first display/operation panel.

33. The data managing method for hair processing sots according to claim 22, wherein the display modes of a list display, i.e., sequential list-wise display, of the spot-visiting history as the above spot-visiting history, and detail display representing details of the service contents concerning a particular spot-visiting day in the list, are obtainable step-wise.

34. The data managing method for hair processing spots according to claim 22, wherein the counseling terminal is arranged such that it can start the retrieval for a hairstyle, which conforms to conditions determined by inputting the customer's present hairstyle and desire on the first display/operation panel in face-to-face relation to the customer, from a hairstyle catalogue database in the database on the basis of an operation with respect to a predetermined display on the first display/operation panel and display a plurality of hairstyle images obtained as a result of retrieval on the second display/operation panel.

35. The data managing method for hair processing spots according to claim 34, wherein the counseling terminal is arranged such that it can display the image of a hairstyle, determined on the basis of a customer's operation on the second display/operation panel, among the plurality of hairstyle images displayed on the second display/operation panel, and input data concerning necessary services on the basis of an operator's operation on the first display/operation panel with the pertinent hairstyle image displayed thereon.

36. The data managing method for hair processing spots according to claim 35, wherein the counseling terminal is arranged such that it preserves data representing the retrieval conditions applied for the hairstyle retrieval, the selected hairstyle, the certified service, etc. in the database.

37. The data managing method for hair processing spots according to claim 22, wherein the accepting terminal is arranged such that it obtains, on the basis of a Predetermined operation on the first display/operation panel in the accepting terminal, customer's hairstyle data after the setting, picked up with a digital camera disposed such as to be capable of supplying image data to it, and displays the customer's hairstyle image after the setting, based on the obtained image data, together with a previously obtained hairstyle image before the setting on both the first and second display/operation panels.

38. The data managing method for hair processing spots according to claim 22, wherein the accepting terminal is arranged such that it obtains, on the basis of a Predetermined operation on the first display/operation panel in the accepting terminal, customer's hairstyle data after the setting, picked up with a digital camera disposed such as to be capable of supplying image data to it, and displays the customer's hairstyle image after the setting, based on the obtained image data, together with a previously obtained hairstyle image before the setting on both the first and second display/operation panels, and prints, on the basis of a predetermined operation on the first display/operation panel, the customer's hairstyle image after the setting based on the obtained image data on a predetermined area of a receipt to be issued to the customer in a printer for receipt printing.

39. The data managing method for hair processing spots according to claim 22, wherein the counseling terminal has an internet connecting function permitting down-loading of hairstyle catalogue data through internet.

40. The data managing method for hair processing spots according to claim 22, wherein the accepting terminal is arranged such that a customer ID preliminarily assigned as peculiar ID to the customer on the basis of a customer's operation with respect to the second display/operation panel.
